(19) United States
(12) Patent Application Publication
(10) Pub. No.: US 2025/0121575 A1
(43) Pub. Date: Apr. 17, 2025

(54) METHOD FOR TEST PRESSING PELLETS IN A ROTARY PRESS AND ROTARY PRESS

(71) Applicant: Fette Compacting GmbH, Schwarzenbek (DE)

(72) Inventors: Jan Naeve, Kehrsen (DE); Werner Seifert, Wentorf (DE); Patrick Liesack, Hamburg (DE); Sven Kolbe, Büchen (DE); Sven Lüdemann, Hamburg (DE)

(73) Assignee: Fette Compacting GmbH, Schwarzenbek (DE)

(21) Appl. No.: 18/913,509

(22) Filed: Oct. 11, 2024

(30) Foreign Application Priority Data
Oct. 12, 2023 (DE) 10 2023 127 940.8

(51) Int. Cl. B30B 11/00; B30B 15/30

(52) U.S. Cl. CPC B30B 11/006; B30B 15/30

(57) ABSTRACT

A method for test pressing pellets in a rotary press includes depositing material to be pressed into one of the plurality of receptacles of a die plate. The upper and a lower press punch are moved such that the upper press punch is positioned in an impact area of an upper test pressing tool of a test pressing apparatus of the rotary press. The lower press punch is positioned in an impact area of a lower test pressing tool of the test pressing apparatus. The upper and the lower test pressing tools are advanced towards each other via a test pressing drive of the test pressing apparatus so that the upper press punch and the lower press punch are driven towards each other in the one of the plurality of receptacles by the upper and lower test pressing tools to press the material in the receptacle into a test pellet.

### CROSS-REFERENCE TO RELATED APPLICATION

This application claims priority to, and benefit of, German Patent Application No. 10 2023 127 940.8, filed Oct. 12, 2023, the entire contents of which are hereby incorporated by reference.

### TECHNOLOGICAL FIELD

The following disclosure is directed to a method for test pressing pellets in a rotary press, wherein the rotary press includes a rotationally driven rotor with upper and lower press punches, an upper and lower punch guide for the upper and lower press punches and a die plate between the punch guides. In some embodiments, the upper and lower press punches interact with receptacles of the die plate in the production mode of the rotary press, also including a filling apparatus in which material to be pressed is filled into the receptacles in the production mode of the rotary press, also including a pressing apparatus with upper and lower pressing tools which interact with the upper and lower press punches in the production mode of the rotary press so that they press material located in the receptacles into pellets. The following disclosure is also directed to a rotary press including a rotationally driven rotor with upper and lower press punches, an upper and lower punch guide for the upper and lower press punches and a die plate between the punch guides, wherein the upper and lower press punches interact with receptacles of the die plate in the production mode of the rotary press. The rotary press also includes a filling apparatus in which material to be pressed is filled into the receptacles in the production mode of the rotary press, and a pressing apparatus with upper and lower pressing tools, which interact with the upper and lower press punches in the production mode of the rotary press so that they press material located in the receptacles into pellets.

### BACKGROUND

Test pressings are performed in order, for example, to determine the optimum setting parameters of the rotary press for manufacturing pellets in the production mode for new materials to be pressed. The pellets can in particular be tablets. In order to press a tablet with minimal product use in the context of a test pressing, individual pressings are desirable in which, for example, only one pellet is generated. Rotary presses are known to be used for the production of pellets in large quantities. In order to bring about the required pressing force to produce the pellet, the press punches move relative to a guide geometry of a pressing apparatus, for example comprising upper and lower compression rollers or compression wedges. The pressing speed and pressure holding time are determined by the rotor rotational speed, by the guide geometry, and by the punch head shape of the press punches. In principle, the guide geometry can be influenced by various measures. For example, guide curves for the press punches can be adapted. These control the axial movement of the press punches over the course of their rotation with the rotor. In addition, it is possible with rotary presses to influence the pressing force by slight axial adjustment of the pressing tools, for example the compression rollers or the compression wedges. If the opposing upper and lower pressing tools are moved closer together, the pellet is compressed more during the pressing process and has a lower web height. This results in a greater pressing force. Naturally, by changing the spacing of the upper and lower pressing tools, the pressings of the subsequent pellets are influenced. In a rotary press, for example, the web height of the pellet is a settable dimension. The hardness of the pellet and the required force to move the pellet through the guide geometry of the rotary press, in particular the pressing apparatus, results therefrom. It is also possible to regulate the pressing force by adapting the web height during operation by the measured pressing force.

In addition, linear presses or single-punch presses are known for test presses and are normally used to produce small quantities of tablets. One area of use is the research and development of new medications and product compositions. Opposing pressing tools are moved towards each other to compress the pellet. This can be done by axial movement of both pressing tools or just one of the pressing tools. The movement is carried out via a linear drive, for example a spindle drive. With this type of single press, both the web height of the pellet and the pressing force can be set as a target value. The other value results from this.

If test pressings with a defined pressing force curve are to be carried out in a rotary press provided for the regular production mode, the spacing of the pressing tools must first be determined, from which the desired pressing force results in each case. This is only possible in a rotary press according to a trial and error method in which a pellet height is first set, the resulting pressing force is evaluated and the pellet height is adapted, wherein these steps must be repeated until the desired pressing force is reached. This requires a considerable amount of material to be pressed. The guide geometry, in particular the spacing of opposing pressing tools, is adapted very slowly in a rotary press and can only be controlled within very restricted limits. The spacing can also be set using the pressing force regulation described above. The setting of the spacing of the punches resulting from the pressing force is in turn very slow in many control steps. Apart from this, the predetermined spacing position of the pressing tools is approached by adjustment drives at a constant speed and not freely controllable. The adjustment of opposing pressing tools can only bring about an adaptation of the pressing force within narrow limits and takes place in ongoing operation of the rotary press. This means that an averaged value is recorded for one or more pellets. This value then serves as the basis for readjusting the spacing of the pressing tools. During this readjustment, more pellets are produced that were not manufactured under the desired conditions and correspondingly form scrap.

Linear presses are contrastingly unsuitable for producing large quantities of pellets. Furthermore, it is also disadvantageous in terms of effort that a separate test press must be provided in addition to the rotary press provided for the production mode. Furthermore, the data generated thereby cannot be transferred directly to the rotary press provided for the production mode, in particular due to different components of the presses and other parameters, such as ventilation of the press room or machine suspension. The generated data must therefore be adapted to the production press. For the adaptation, it is routinely necessary to carry out additional test pressings on the rotary press provided for the production mode, which further increases the effort.

DE 103 19 024 B3 discloses a method for the test pressing of tablets in a rotary tabletting machine, which is carried out in a rotary press provided for the regular production mode. A punch pair selected for an individual pressing is automatically moved to a filling position, and a die or a limited number of dies are filled with material with an at least partially remote filling arrangement and stationary rotor. The rotor is then set in rotation and accelerated so that it has the desired production speed in the pressing station of the rotary press. After one revolution, the rotor is stopped again in the filling position. During the rotation of the rotor, signals or signal curves from the measuring points are recorded and sent to a computer for display and evaluation. The advantage of this method is that no separate test press is required for the test pressing. This reduces the effort. At the same time, the data obtained in the context of test pressing can be used directly and substantially without adaptation since it has already been produced on the rotary press provided for the production mode. The effort is also thereby reduced. In that only one or a few dies are filled with material, the amount of product input required for the test pressing can also be kept to a minimum. However, the web height of the produced tablet must be estimated during the first test pressing based on the filling quantity in the die so that an initially unknown pressing force arises at the pressing station. The desired pressing force for the particular product must be accordingly determined in a series of test pressings. This further increases the effort and the product input.

### BRIEF SUMMARY OF THE INVENTION

Proceeding from the prior art described above, the invention is based on the object of providing a method and a rotary press of the type mentioned at the outset, which enable a test pressing for setting a rotary press for a production mode reliably and with little effort.

Aspects of the present disclosure are directed to embodiments of a method of the type mentioned at the outset. In some embodiments, the method includes filling material to be pressed into a receptacle, and bringing a punch pair consisting of upper and lower press punches assigned to the die plate receptacle into a test pressing position in which the upper press punch is located in an impact area of an upper test pressing tool of a test pressing apparatus of the rotary press, and the lower press punch is located in an impact area of a lower test pressing tool of the test pressing apparatus. Some embodiments of the method further include moving the upper and the lower test pressing tools towards each other by means of a test pressing drive of the test pressing apparatus so that the upper press punch and the lower press punch are pressed towards each other in the receptacle of the die plate by the upper and lower test pressing tools to press the material filled into the receptacle into a test pellet.

Aspects of the present disclosure are further directed to embodiments of a rotary press including a test pressing apparatus comprising an upper test pressing tool and a lower test pressing tool, wherein for test pressing, the upper test pressing tool interacts with an upper press punch assigned to a receptacle of the die plate, and the lower test pressing tool interacts with a lower press punch assigned to the same receptacle. In some embodiments, the rotary press includes a test pressing drive which moves the upper test pressing tool and the lower test pressing tool towards each other for a test pressing so that the upper press punch and the lower press punch are pressed towards each other in the receptacle of the die plate by the upper and lower test pressing tools to press material filled into the receptacle into a test pellet.

In some embodiments, the rotary press according to the invention or respectively the rotary press used in the method according to the invention is a rotary press which is provided for the regular production mode of pellets, in particular tablets, made in particular of powdery material. In a manner known per se, the rotary press comprises a rotor with a plurality of upper and lower press punches which are each assigned in pairs to a receptacle or respectively a cavity of a die plate. The receptacles can be structured as direct bores in the die plate. However, they can also be structured as sleeve-like inserts which are inserted into correspondingly larger receptacles of the die plate. During operation of the rotary press, the upper and lower press punches rotate together with the die plate, whereby their axial movement is controlled by control cams and guided by upper and lower punch guides. The control cams generally interact with the punch heads of the press punches. In the course of rotation, the die plate passes through various apparatuses of the rotary press in the production mode, namely a filling apparatus in which powder material to be pressed is filled into the receptacles of the die plate and a pressing apparatus in which the upper and lower press punches are pressed into the receptacles by upper and lower pressing tools, for example upper and lower compression rollers, to press the powder material into pellets, such as tablets. The pressing apparatus can have upper and lower pre-pressing tools, in particular pre-compression rollers, as well as upper and lower main pressing tools, in particular main compression rollers. As an alternative to compression rollers, compression wedges are also possible. Downstream from the pressing apparatus, the upper press punches are guided upwards out of the receptacles in the production mode, and the pellets produced in the receptacles are pushed onto the upper side of the die plate by the lower press punches. Ejector cams are provided for this purpose, which move the lower press punches upwards. The pellets are then scraped off the die plate, for example by a scraper, into an outlet of the rotary press, from where they are fed to further processing. The control cams generally also comprise metering cams which bring the lower press punch into a predetermined position partially inserted into the receptacle when the upper press punch is guided upwards out of the particular receptacle. In this metering position, the lower press punch forms a base of the particular receptacle and therefore defines the filling height of the material filled into the receptacle.

In some embodiments, the rotary press used according to the invention is a rotary press provided for the regular production mode. It can, as explained in more detail below, be adapted to carry out the method according to the invention. In particular, components of the rotary press, for example upper and lower press punches and/or the filling apparatus, can be removed before the start of a test pressing.

In some embodiments, the rotary press includes a test pressing apparatus comprising an upper test pressing tool and a lower test pressing tool. In the method according to the invention, a punch pair assigned to a die plate receptacle, comprising an upper and an opposing lower press punch, is brought into a test pressing position in which the upper press punch is located in an impact area of the upper test pressing tool, and the lower press punch is located in an impact area of the lower test pressing tool. The punch pair can be brought into the test pressing position by rotatingly driving the rotor into a position in which the punch pair is located in the impact area of the test pressing tools. Before, at the same time as or after bringing the punch pair into the test pressing position, material to be pressed is filled into the receptacle to which the punch pair is assigned. The receptacle can be filled manually, for example. The receptacle can be filled to the maximum. Any excess material can be scraped off the upper side of the die plate. It is also possible to only partially fill the receptacle so that a previously weighed quantity can be reliably and completely received by the receptacle and then pressed. The upper and the lower test pressing tools are then moved towards each other by a test pressing drive of the test pressing apparatus so that the upper and lower test pressing tools first come into contact with the upper and lower press punches, respectively, and press the upper and lower press punches against each other in such a way that the punch pair presses the material in the receptacle into a test pellet. It is possible for the upper and lower test pressing tool to move both the upper press punch axially towards the lower press punch as well as to move the lower press punch axially towards the upper press punch. However, it is also possible, for example, that only one of the press punches is moved axially and pressed against the other press punch axially fixed by the particular test pressing tool. In this case, the press punches are located with their punch tips within the receptacle as in a regular pressing of a pellet and press the material between their punch tips to form the pellet, for example a tablet.

After conclusion of the test pressing, the upper and lower test pressing tools can be moved apart by means of the test pressing drive, and the produced test pellet can be removed. To do this, the rotor can, for example, be rotated into an ejection position in which the upper press punch is moved upwards out of the receptacle and the produced test pellet is pushed onto the upper side of the die plate by the lower press punch.

In some embodiments, a test pressing apparatus is therefore provided which, in the environment of a rotary press provided for the regular production mode, reproduces the properties of a linear press for the individual pressing of pellets. The test pressing apparatus with the test pressing drive allows individually controlled and therefore dynamic driving of the test pressing tools towards each other so that pressing the material into the test pellet occurs. A regular pressing process in the rotary press can be reproduced reliably and precisely by the possible individual controlling of the test pressing drive, possibly automatically according to previously selected parameters or respectively path curves. The test pressing drive can also be regulated during the test pressing and fulfills the advantageous properties of a linear press, as explained at the outset, without taking on its disadvantages. As already mentioned, the rotary drive of the rotor can be used to bring the punch pair into the test pressing position. The rotary drive can also be used to fix the press punches during the test pressing so that they cannot move radially during the pressing process, for example.

By integrating according to the invention a test pressing apparatus for single individual pressings into a rotary press provided for the production mode, the acquisition cost and training cost for personnel for a separate linear press can be avoided. The usually scarce installation space in laboratories in which such presses are often operated, is saved. The test pressing environment inside the rotary press is the same as for the subsequent production mode. This means that influences such as humidity, ventilation of the press room, type of pressing tools, machine suspension, etc. are the same, and the obtained data is directly transferable to the subsequent production mode. Since the components for the test pressing, in particular the test pressing apparatus, are integrated into the rotary press, it may not be necessary to convert the rotary press in order to switch to the production mode. In principle, it is possible to directly switch from individual pressing within the context of a test pressing to the production mode. The values determined in the context of test pressing can be used directly and without further adaptation for the subsequent production mode.

In some embodiments, it can be provided that the pressing force and/or a parameter characterizing the pressing force is determined during the test pressing, and that when a predetermined pressing force and/or a predetermined value of the parameter characterizing the pressing force is reached, the test pressing is ended by moving apart the upper and lower test pressing tools. This is a very important parameter for setting rotary presses for the production mode. In addition, the method according to the invention or respectively the rotary press configured for this purpose according to the invention ensures that the pressing force desired in each case is reliably reached with the first pressing process and is not exceeded. Complex trial and error procedures can be omitted.

In some embodiments, the parameter characterizing the pressing force can be a web height, a pressing force curve, and/or a pressure holding time at a specified pressing force. The web height can, for example, be determined via the axial path of the upper and lower press punch. The pressure holding time is a travel holding phase. It describes the time period during which the pellet is compressed to its smallest volume. The pressing force can vary during this time period. The path of the punches no longer changes. The pressing force curve can be recorded over time. The pressing force and/or the parameter characterizing the pressing force can be taken into account for setting the rotary press for the production mode.

In some embodiments, it is possible that only the punch pair assigned to the receptacle of the die plate is installed in the rotor during the test pressing. The other punch pairs of the rotor can be removed. Of course, it would also be possible to leave some of the punch pairs of the rotor in the rotor and to remove some punch pairs or to leave all punch pairs in the rotor. The presence of only the punch pair used for the test pressing has the advantage that there is no additional interaction between the punch pairs and components of the rotary press.

In some embodiments, the filling apparatus of the rotary press can be removed or deactivated during the test pressing. This has the advantage that the receptacles not used during the test pressing are not undesirably filled with material to be pressed. It is possible, for example, to completely or partially remove the filling apparatus from the rotor. However, it can also be emptied, or a filling opening can be closed through which material is filled from the filling apparatus into the receptacles. Elaborate measures to prevent the filling of receptacles, for example the insertion of dummy dies, can therefore be avoided.

In some embodiments, the material to be pressed during the test pressing can be manually filled into the receptacle. However, it is also conceivable to fill the material into the receptacle using the filling apparatus or another filling device.

In some embodiments, it can be provided that several test pressings are performed, wherein the pressing force curve and/or the punch path curve are varied by varying the drive speed of the test pressing drive. For example, a sinusoidal and/or sawtooth-shaped and/or rectangular pressing force curve and/or punch path curve can be set by the test drive within the context of the test pressing or within the context of several test pressings. Due to the largely freely controllable or respectively regulatable test pressing drive of the test pressing apparatus according to the invention, largely freely defined path curves can be specified and run through in the context of one or more test pressings. The different path curves can be pressings in different rotary presses as well as standardized path curves, for example to find suitable parameters for new products consisting of material to be pressed. Finding the optimum setting for the rotary press for the subsequent production mode is thereby facilitated.

In some embodiments, it can be provided that the upper and lower test pressing tools are moved apart by means of the test pressing drive after a first test pressing process, and are then moved towards each other again by means of the test pressing drive so that the upper press punch and the lower press punch are pressed towards each other in the receptacle of the die plate by the upper and lower test pressing tools to additionally press the material filled into the receptacle into a test pellet. In this way, multiple pressings can be simulated, as is the case, for example, with pressing apparatuses with several pressing tools that pass through sequentially during the rotation of the rotor, such as several compression rollers, in particular pre-compression rollers and main compression rollers. This allows the later production mode to be simulated even better in the context of the test pressing so that the optimum setting parameters of the rotary press can be found.

In some embodiments, the test pressing drive is a linear drive. In particular, two test pressing drives can be provided, one of which drives the upper test pressing tool and the other of which drives the lower test pressing tool. The test pressing drives can be individually controllable or respectively regulatable so that the test pressing can be performed particularly flexibly. According to a particularly practical embodiment, the test pressing drive can comprise an electric or hydraulic drive. Such drives can be controlled or respectively regulated particularly precisely and flexibly and are therefore particularly suitable for the invention. In contrast to a normally provided adjustment drive for the pressing tools, in particular the compression rollers, of the pressing apparatus, the test pressing drive actively serves to press a pellet. The usually provided adjustment drive merely serves to set the height of the pressing tools. The kinetic energy is provided by the main drive of the rotary press driving the rotor. The test pressing drive is also in principle an adjustment drive, but itself provides the feed of the press punches for pressing the material in the receptacle into a pellet. While a conventional adjustment drive for pressing tools such as compression rollers can only be moved to a target point, it is possible to travel a defined path curve with the test pressing drive. Other parameters such as the pressing force influence the path curve. Accordingly with the test pressing drive, a single-punch press can be simulated in the environment of a conventional rotary press.

In some embodiments, the rotary press can also comprise a control apparatus which is designed to control the test pressing drive. The method according to the invention can, for example, be controlled by the control apparatus of the rotary press, in particular automatically, except for manually filling the receptacle. The control apparatus can be formed by or respectively integrated into the machine control system for controlling the rotary press in the production mode. Based on the results of the test pressing, the rotary press can be configured with all the components for the later production mode. This can also be done by the control apparatus. This concerns, for example, the desired setting of the metering cams and/or the pressing apparatus, in particular the pressing tools such as compression rollers, and/or the rotational speed of the rotor. Insofar as parameters are determined according to the invention, such as for example the pressing force or a parameter characterizing the pressing force, these parameters can be measured by means of corresponding sensors. For this purpose, the rotary press according to the invention can have corresponding sensors, for example pressing force sensors on the pressing apparatus, for example arranged on pressing tools, in particular compression rollers. The parameter characterizing the pressing force curve and/or any other determined parameters can also be measured by means of corresponding sensors of the rotary press.

In some embodiments, the upper and lower test pressing tools can be formed by the upper and lower pressing tools of the pressing apparatus. The pressing tools, for example upper and lower compression rollers, generally already have linear guides or eccentric guides via which they can be set to a defined distance by means of an adjustment apparatus. In addition, the receptacles of the pressing tools frequently already have a pressing force sensor which can serve to measure the pressing force and regulate the drives, for example the rotary drive of the rotor and/or the test pressing drive. As explained, usually provided adjustment drives for the axial adjustment of pressing tools such as compression rollers are unsuitable for carrying out the test pressing according to the invention. In particular, the test pressing drive can replace an adjustment drive for adjusting the upper and lower pressing tools. The test pressing drive can also comprise a gearbox that can replace a gearbox of the adjustment drive.

In addition to the pressing tools, other positions on the rotor are, however, also possible in order to integrate the test pressing apparatus with the test pressing drive. Accordingly, the upper and lower test pressing tools can be test pressing tools designed separately from the pressing apparatus, which do not necessarily participate in the production mode of the rotary press. For example, upper and lower actuators driven by means of the test pressing drive can be arranged at a rotor position separate from the pressing apparatus and can be pressed towards each other accordingly by means of the test pressing drive so that the upper and lower press punches located in the test pressing position press the material filled into the receptacle into the test pellet. In this case, it is unnecessary to change the pressing apparatus of the rotary press for the integration according to the invention of the test pressing apparatus. In the regular production mode, the actuators can form upper and lower guide curve elements in a particularly practical manner to guide the press punches rotating with the rotor. This makes it very easy to convert existing rotary presses in that upper and lower control cam elements at a test pressing position are removed and replaced by the upper and lower actuators driven by the test pressing drive. In some embodiments, the upper and lower pressing tools can, as already explained, be formed by upper and lower compression rollers or compression wedges. Some embodiments of the method according to the invention can be performed with the rotary press according to the invention. Accordingly, the rotary press according to the invention can be designed to perform the method according to the invention.

### BRIEF DESCRIPTION OF THE DRAWINGS

One exemplary embodiment of the invention is explained below in greater detail using figures.

FIG. 1 schematically shows an embodiment of rotary press according to the invention and used in the method according to the invention.

FIG. 2A schematically illustrates an example of a sinusoidal pressing force curve according to the invention and used in the method according to the method.

FIG. 2B schematically illustrates an example of a sawtooth-shaped pressing force curve according to the invention and used in the method according to the method.

FIG. 2C schematically illustrates an example of a multiple pressing force curve according to the invention and used in the method according to the method.

FIG. 2D schematically illustrates an example of a rectangular pressing force curve according to the invention and used in the method according to the method.

If not otherwise specified, the same reference numbers indicate the same objects in the figures.

### DETAILED DESCRIPTION OF THE INVENTION

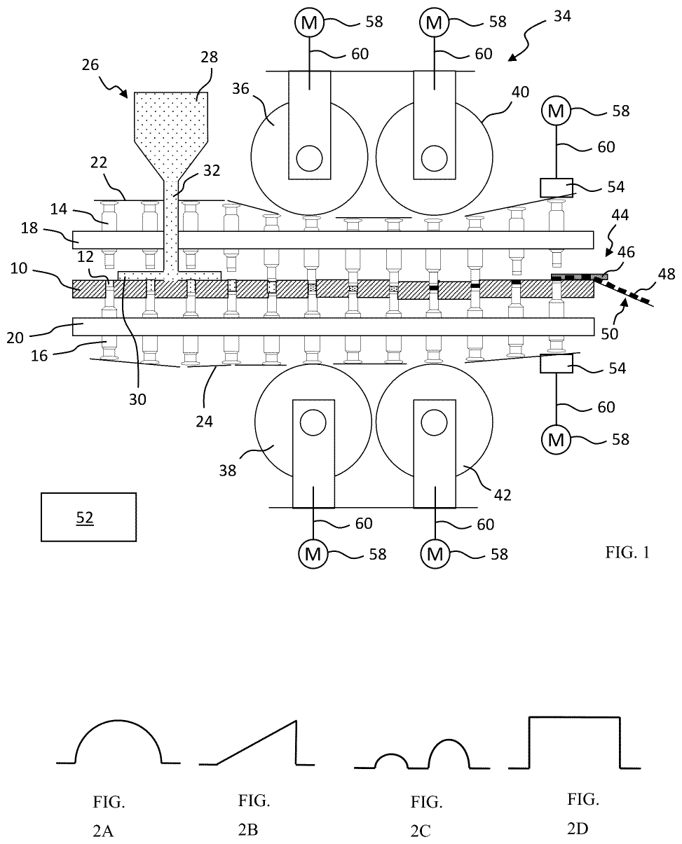

The rotary press shown in FIG. 1 is a rotary press for tablet production as can be used in the present invention and in which powdery material is pressed into pellets, in particular tablets. The rotor of the rotary press is driven in rotation by a rotary drive and comprises a die plate 10 which has a plurality of receptacles 12. The receptacles 12 can, for example, be formed by holes in the die plate 10. In addition, the rotor comprises a plurality of upper press punches 14 and lower press punches 16 which circulate synchronously with the die plate 10. The upper press punches 14 are axially guided in an upper punch guide 18, and the lower press punches 16 are axially guided in a lower punch guide 20. The axial movement of the upper press punch 14 and lower press punch 16 in the course of the rotation of the rotor is controlled by upper control cam elements 22 and lower control cam elements 24. Furthermore, a filling apparatus 26 is provided which has a filling reservoir 28 and a filling chamber 30 which are connected via a filling tube 32. In this way, in the present example, powdery material passes under gravity from the filling reservoir 28 via the filling tube 32 into the filling chamber 30 and from there via a filling opening provided in the underside of the filling chamber 30, in turn under gravity into the receptacles 12 of the die plate 10.

The rotary press also comprises a pressing apparatus 34. In the shown example, the pressing apparatus 34 comprises a pre-pressing apparatus with an upper compression roller 36 held on an upper holder and a lower compression roller 38 held on a lower holder, as well as a main pressing apparatus with an upper compression roller 40 held on an upper holder and a lower compression roller 42 held on a lower holder. In addition, the rotary press comprises an ejection apparatus 44 and a scraping apparatus 46 with a scraping element which feeds the tablets 48 produced in the rotary press to a discharge apparatus 50 for discharging from the rotary press. The scraping apparatus 46 can, for example, comprise a preferably sickle-shaped scraping element which, in the area of the ejection apparatus 44, scrapes tablets 48 conveyed onto the upper side of the die plate 10 by the lower press punches 16 from the die plate 10 and feeds them to the discharge apparatus 50.

Furthermore, the rotary press comprises a control apparatus 52 for controlling the operation of the rotary press and for performing the method according to the invention, as explained in more detail below.

In some embodiments, the rotary press according to the invention also comprises a test pressing apparatus for the test pressing of pellets in the rotary press. For the sake of illustration, three possible configurations of test pressing apparatuses are shown in FIG. 1. All or some can be provided in combination in the rotary press. However, it is also possible that only one of the shown test pressing apparatuses is provided.

In some embodiments, a first upper test pressing tool 36 and lower test pressing tool 38 are formed by the upper compression roller 36 and the lower compression roller 38, respectively, of the pre-pressing apparatus. The upper compression roller 40 and the lower compression roller 42 of the main pressing apparatus 34 form a second upper test pressing tool 40 and lower test pressing tool 42, respectively. Furthermore, a third upper test pressing tool 54 and a third lower test pressing tool 56 are provided in FIG. 1 in the area of the ejection position of the rotor and are designed as actuators that can replace the corresponding control cam elements in the area of the ejection position.

In some embodiments, a test pressing drive 58 is assigned to each of the upper and lower test pressing tools 36, 38, 40, 42, 54, 56. The test pressing drives 58 each act, via a connection 60, on the test pressing tool 36, 38, 40, 42, 54, 56 assigned to them. The connections 60 can form or comprise a gearbox of the particular test pressing drive 58. For example, the connections 60 can each comprise a toothed belt, toothed belt pulleys, a planetary screw drive together with a nut, and a drive shaft. The test pressing drives 58 can, for example, be hydraulic or electric drives.

For a test pressing with the first test pressing apparatus, a punch pair including an upper and a lower press punch 14, 16 assigned to a receptacle 12 of the die plate 10 is brought into a test pressing position, which is arranged in the present case in the area of the smallest spacing of the upper compression roller 36 and the lower compression roller 38 as the first upper test pressing tool 36 and the first lower test pressing tool 38. To this end, the upper compression roller 36 as the upper test pressing tool 36 and the lower compression roller 38 as the lower test pressing tool 38 are first moved apart from each other by means of the test pressing drives 58 so that the punch pair can be easily brought into the test pressing position, for example by rotating the rotor. Before, during or after moving into the test pressing position, the receptacle 12 assigned to the punch pair is filled with the material to be pressed, for example manually. Subsequently, the upper and lower compression rollers 36, 38 as first upper and lower test pressing tools 36, 38 are moved towards each other by means of each of the assigned test pressing drives 58 so that the upper press punch 14 and the lower press punch 16 of the punch pair are pressed towards each other in the receptacle 12 of the die plate 10 by the upper and lower test pressing tools 36, 38 to press the material filled into the receptacle into a test pellet. After completion of the test pressing, the first upper and lower test pressing tools 36, 38 can in turn be moved apart from each other in a controlled manner by the test pressing drives 58 so that the test pellet can be removed from the receptacle 12. For this purpose, the rotor can be moved into an ejection position in which the lower press punch 16 ejects the test pellet produced onto the upper side of the die plate 10. In some embodiments, the test pressing drives 58 are in communication with and can be controlled by the control apparatus 52 in the same way as the control of the rotor. As explained in more detail below, for example, a previously defined pressing force can be realized in the context of the test pressing. Different pressing force curves or punch travel curves can also be realized. On this basis, the rotary press can be optimally set for the later production mode. In the present example, the test pressing drives 58 act on the compression rollers 36, 40 or respectively 38, 42 as test pressing tools. They can replace an adjustment drive of the compression rollers 36, 40 or respectively 38, 42 for setting the axial spacing between the compression rollers 36, 40 or respectively 38, 42, if necessary including a gearbox of the adjustment drive.

In the same way as for the first test pressing apparatus with the compression rollers 36 and 38 as the first test pressing tools, test pressing can be carried out by means of the second and third test pressing apparatuses shown in FIG. 1. The test pressing positions into which the punch pair are brought, for example by corresponding rotation of the rotor, differ in this case. In particular, the punch pair for carrying out a test pressing with the second test pressing apparatus comprising the compression rollers 40 and 42 as second upper and lower test pressing tools 40, 42, is located at a rotational position of the rotor which corresponds to the smallest spacing between of the upper and lower compression rollers 40, 42. As soon as this position is reached, a test pressing can also be carried out with the second test pressing apparatus in the manner described above for the first test pressing apparatus.

Accordingly, a test pressing can be carried out with the third test pressing apparatus, wherein in this case, the test pressing position corresponds to the position of the punch pair shown on the far right in FIG. 1. As soon as this position has been assumed, a test pressing can be carried out again, if necessary after moving apart the third test pressing tools 54, 56 by means of the test pressing drives 58 and filling the receptacle 12 with the material to be pressed, in that the third test pressing tools 54, 56 are pressed towards each other by means of the associated test pressing drives 58. It is understood that the lower press punch 16 is moved further down for this purpose so that filling the receptacle 12 to the desired filling height is possible.

As explained, the rotary press according to the invention can be used to perform test pressings with different pressing force curves. It is also possible for the rotary press to have pressing force sensors in the area of the explained test pressing apparatuses to measure the pressing force during the test pressing. In this way, it can be ensured that a desired pressing force is reliably reached and not exceeded.

FIGS. 2A-D show different examples of possible pressing force curves, for example over time. FIG. 2A shows a sinusoidal pressing force curve, FIG. 2B shows a sawtooth-shaped pressing force curve, FIG. 2C shows a multiple pressing force curve, and FIG. 2D shows a rectangular pressing force curve. The multiple pressing force curve can, for example, simulate pressing in a rotary press with pre-pressing and main pressing apparatuses which the press punches pass through sequentially during rotation. The different heights of the particular pressing force curves in FIG. 2C simulate the lower pressing force in the area of the pre-pressing apparatus compared to the main pressing apparatus.

### LIST OF REFERENCE SIGNS

10 Die plate
12 Receptacle
14 Upper press punch
16 Lower press punch
18 Upper punch guide
20 Lower punch guide
22 Upper control cam element
24 Lower control cam element
26 Filling apparatus
28 Filling reservoir
30 Filling chamber
32 Filling tube
34 Main pressing apparatus
36, 40, 54 Upper compression roller/test pressing tool
38, 42, 56 Lower compression roller/test pressing tool
44 Ejection apparatus
46 Scraping apparatus
48 Pellet
50 Discharge apparatus
52 Control apparatus
58 Test pressing drive
60 Connection

1. A method for test pressing pellets in a rotary press, comprising:
providing a rotary press comprising,
upper and lower press punches,
an upper and lower punch guide configured to guide the upper and lower press punches, respectively,
a die plate positioned between the punch guides and defining a plurality of receptacles, wherein the upper and lower press punches interact with the plurality of receptacles of the die plate in a production mode of the rotary press,
a filling apparatus configured to fill a material into the receptacles in the production mode of the rotary press,
a pressing apparatus comprising upper and lower pressing tools configured to interact with the upper and lower press punches in the production mode of the rotary press to press the material in the receptacles into pellets;
depositing material to be pressed into one of the plurality of receptacles of a die plate;
moving the upper and a lower press punch into a test pressing position such that the upper press punch is positioned in an impact area of an upper test pressing tool of a test pressing apparatus of the rotary press, and the lower press punch is positioned in an impact area of a lower test pressing tool of the test pressing apparatus; and
advancing the upper and the lower test pressing tools towards each other via a test pressing drive of the test pressing apparatus so that the upper press punch and the lower press punch are pressed towards each other in the receptacle of the die plate by the upper and lower test pressing tools to press the material filled into the receptacle into a test pellet.

2. The method according to claim 1, further comprising:
determining at least one of a pressing force and a parameter of the pressing force during the test pressing; and
moving apart the upper and lower test pressing tools when at least one of a predetermined pressing force and a predetermined value of the parameter of the pressing force is reached.

3. The method according to claim 2, wherein the parameter of the pressing force comprises at least one of: (i) a web height; (ii) a pressing force curve; and (iii) a pressure holding time at a predetermined pressing force.

4. The method according to claim 2, further comprising setting the rotary press for the production mode based on the at least one of the pressing force and the parameter of the pressing force.

5. The method according to claim 1, further comprising installing only the upper and lower punches to the one of the plurality of receptacles during the test pressing.

6. The method according to claim 1, further comprising manually depositing the material to be pressed during the test pressing into the one of the plurality of receptacles.

7. The method according to claim 1, further comprising:
performing multiple test pressings; and
varying at least one of a pressing force curve and a punch path curve by varying a drive speed of the test pressing drive.

8. The method according to claim 1, further comprising setting a drive speed of the test pressing drive to produce at least one of: (i) a sinusoidal pressing force curve; (ii) a sawtooth-shaped pressing force curve; (iii) a rectangular pressing force curve; and (iv) a punch path curve during one or more test pressings.

9. The method according to claim 1, further comprising:
moving the upper and lower test pressing tools apart by the test pressing drive after a first test pressing process; and
moving the upper and lower test pressing tools towards by means of the test pressing drive so that the upper press punch (14) and the lower press punch (16) are pressed towards each other in the one of the plurality of receptacles (12) of the die plate (10) by the upper and lower test pressing tools for additionally pressing the material in the one of the plurality of receptacles (12) into a test pellet.

10. A rotary press comprising:
upper and lower press punches;
an upper and lower punch guide configured to guide the upper and lower press punches;
a die plate positioned between the punch guides and defining a plurality of receptacles, wherein the upper and lower press punches interact with the plurality of receptacles of the die plate in a production mode of the rotary press;
a filling apparatus configured to deposit a material to be pressed into the plurality of receptacles in the production mode of the rotary press;
a pressing apparatus including upper and lower pressing tools that are configured to interact with the upper and lower press punches in the production mode of the rotary press to press the material in the receptacles into pellets;
a test pressing apparatus comprising an upper test pressing tool and a lower test pressing tool, wherein for a test pressing, the upper test pressing tool is configured to interact with an upper press punch (14) assigned to one of the plurality of receptacles, and the lower test pressing tool is configured to interact with a lower press punch assigned to the one of the plurality of receptacles; and
a test pressing drive configured to drive the upper test pressing tool and the lower test pressing tool towards each other during the test pressing so that the upper press punch and the lower press punch are advanced towards each other in the one of the plurality of receptacles by the upper and lower test pressing tools so as to press the material the one of the plurality of receptacles into a test pellet.

11. The rotary press according to claim 10, wherein the test pressing drive comprises one of an electric and hydraulic drive.

12. The rotary press according to claim 10, wherein the rotary press comprises a control apparatus configured to control the test pressing drive.

13. The rotary press according to claim 10, wherein the upper and lower test pressing tools are formed by the upper and lower pressing tools of the pressing apparatus.

14. The rotary press according to claim 10, wherein the upper and lower test pressing tools comprise test pressing tools formed separately from the pressing apparatus.

15. The rotary press according to claim 10, wherein the upper and lower pressing tools comprise upper and lower compression rollers.

16. The rotary press according to claim 10, further configured to:
drive the upper and a lower press punch into a test pressing position such that the upper press punch is positioned in an impact area of an upper test pressing tool of the test pressing apparatus, and such that the lower press punch is positioned in an impact area of a lower test pressing tool of the test pressing apparatus; and
advance the upper and the lower test pressing tools towards each other by means of a test pressing drive of the test pressing apparatus so that the upper press punch and the lower press punch are pressed towards each other in the one of the plurality of receptacles by the upper and lower test pressing tools to press the material in the one of the plurality of receptacles into a test pellet.
